(19) United States
(12) Patent Application Publication
(10) Pub. No.: US 2012/0026139 A1
(43) Pub. Date: Feb. 2, 2012

(54) LIGHT FEEDBACK CONTROL SYSTEM FOR A DISPLAY DEVICE AND METHOD FOR FEEDBACK CONTROL

(76) Inventor: Wei-Jen Chou, Taipei County (TW)

(21) Appl. No.: 12/883,184

(22) Filed: Sep. 16, 2010

(30) Foreign Application Priority Data
Jul. 28, 2010 (TW) 099124889

(51) Int. Cl. G09G 5/00; G09G 3/36

(52) U.S. Cl. 345/207; 345/102

(57) ABSTRACT

A light feedback control system can obtain a correct light feedback signal for a backlight source by using an optical sensor disposed inside a backlight unit or outside a display device after subtracting the effect of ambient light sensed by the optical sensor when a backlight element is turned off. The optical sensor senses light intensity and the ambient light source at a double frequency of the frequency at which a backlight element emits light. The light feedback control system may further control the ambient light source and the backlight element, driving them to illuminate alternately, while the optical sensor synchronizes with the backlight element and senses light signals of the backlight element. Accordingly, exact information about the light intensity or color of the backlight element can be obtained for feedback control of the display device.

### BACKGROUND OF THE INVENTION

1. Field of the Invention

The invention relates to a light feedback control system for a display device and a method for feedback control, and more particularly, to a light feedback control system and a method for feedback control which are used for monitoring light intensity or color signal of a light source.

2. Description of the Prior Art

Optical performance of a light emitting element in a liquid crystal display device decays due to various factors. For example, light emitting characteristic of a light emitting diode (LED) decays due to heat or long-time use. Accordingly, an optical sensor is usually added into a backlight unit (BLU) with light emitting diodes as its light source, so as to perform the feedback control for the backlight unit. Practically, optical sensors can further be categorized into light sensors and color sensors, which are utilized in feedback control on light intensity and color respectively.

Because transmittance rates of liquid crystal panels are gradually improved, TV panels may have transmittance rates up to 5 percent, and 20 percent for liquid crystal panels without color filters. In such conditions, when one of the aforesaid optical sensors detects alight signal of the backlight unit, the optical sensor also receives a signal of ambient light due to an external ambient light source. Accordingly, it will result in an error of the feedback control.

### SUMMARY OF THE INVENTION

The present invention provides a light feedback control system capable of feeding precise optical characteristics of a backlight element and calibrating the optical performance of the backlight element.

The present invention also provides a method for feedback control capable of obtaining a correct feedback signal.

The present invention provides a light feedback control system. The light feedback control system includes a light source driver, an optical sensor, and a controller. The light source driver is connected to a backlight element for driving the backlight element. The controller is connected to the optical sensor and the light source driver, and the controller controls the optical sensor to sense a light source both when the backlight element is turned on and turned off so as to generate a plurality of signals correspondingly. The controller computes a feedback signal according to the plurality of signals, and the feedback signal is used for calibrating optical performance of the backlight element.

The present invention also provides a light feedback control system. The light feedback control system includes a light source driver, an optical sensor, and a controller. The light source driver is connected to a backlight element for driving the backlight element when an ambient illuminating device is turned off. The controller is connected to the optical sensor and the light source driver. The controller controls the optical sensor to synchronize with the light source driver and sense a light source so as to output a feedback signal. The feedback signal is used for calibrating optical performance of the backlight element.

The present invention also provides a light feedback control method including following steps: driving a back light element intermittently; sensing a light source and outputting a first signal correspondingly when the backlight element is turned on; sensing the light source and outputting a second signal correspondingly when the backlight element is turned off; computing a feedback signal according to the first signal and the second signal; calibrating optical performance of the backlight element according to the feedback signal.

The present invention also provides a light feedback control method including following steps: driving a backlight element and an ambient illuminating device intermittently and alternately; sensing a light source and outputting a feedback signal correspondingly when the backlight element is turned on; calibrating optical performance of the backlight element according to the feedback signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a light feedback control system of a first embodiment of the present invention.

FIG. 2 is a schematic diagram showing an optical sensor sampling and outputting a feedback signal in the first embodiment of the present invention.

FIG. 3 is a block diagram of a light feedback control system of a second embodiment of the present invention.

FIG. 4 is a schematic diagram showing an optical sensor sampling and outputting a feedback signal in the second embodiment of the present invention.

FIG. 5 is a block diagram of a light feedback control system of a third embodiment of the present invention.

### DETAILED DESCRIPTION

A light feedback control system of the present invention incorporates synchronizing control technology of an optical sensor into a display device (such as a flat display panel device or a flat TV that use light emitting diodes or cold cathode fluorescent lamps as a backlight light source), so as to obtain more precise feedback information for the backlight light source and to provide a correct feedback signal for the display device such that the lights emitted from the backlight light source of the display device can be optimized.

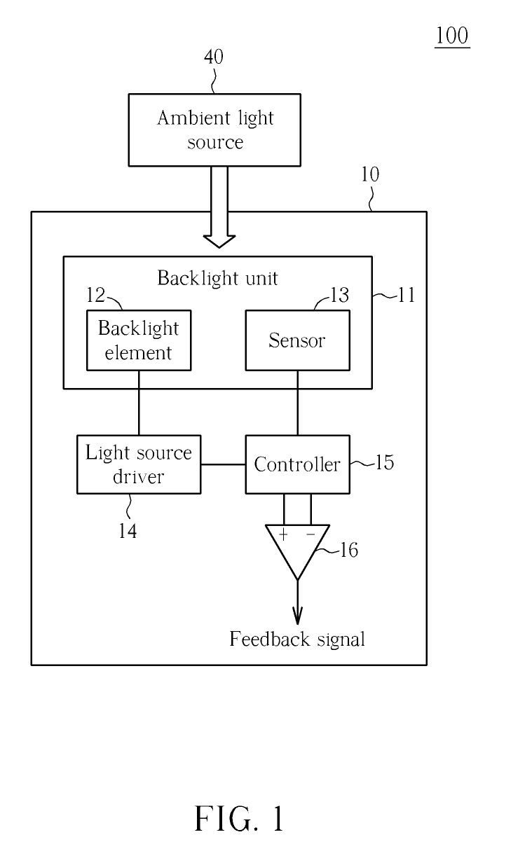

Please refer to FIG. 1. FIG. 1 is a block diagram of a light feedback control system 100 of a first embodiment of the present invention. The light feedback control system 100 is implemented in a display device 10, wherein the display device 10 includes a backlight unit 11 including a plurality of backlight elements 12 (only one backlight element is shown in FIG. 1). In this embodiment, the backlight unit 11 can include backlight elements 12 such as cold cathode fluorescent lamps, white light emitting diodes, or light emitting elements 12 composed of red light LEDs, green light LEDs, and blue light LEDs. The backlight elements 12 are used for providing the display device 10 with a backlight and controlled to emit lights at a specific frequency by a light source driver 14, which can be a pulse width modulation (PWM) circuit or an inverter. An optical sensor 13 is disposed in the backlight unit 11. In practical application, the optical sensor 13 can be a color sensor capable of sensing light intensity and color signal of red, green, blue lights emitted from the emitting diodes, or a light sensor capable of sensing light intensity of the white light emitting diodes.

Since the optical sensor 13 in the backlight unit 11 senses not only a signal of the backlight elements 12 but also alight signal of an ambient light source 40 that penetrates a liquid crystal panel (not shown) and enters the backlight unit 11, the ambient light source 40 affects the optical sensor 13 such that a sensing signal outputted from the optical sensor 13 is not only contributed by the backlight elements 12. Accordingly, a controller 15 connected to the optical sensor 13 and the light source driver 14 is disposed in the light feedback control system 100, and the controller 15 controls the optical sensor 13 to sense a light source both when the light source driver 14 drives the backlight elements 12 to be turned on and turned off so as to generate a plurality of signals correspondingly. When the light source driver 14 drives the backlight elements 12 in the backlight unit 11 to be turned on, the optical sensor 13 senses light intensity of a backlight light source of the backlight elements 12 adding a light source of the ambient light source 40. When the light source driver 14 does not drive the backlight elements 12 of the backlight unit 11 to be turned on, the optical sensor 13 senses light intensity of the light source of the ambient light source 40. The controller 15 then uses a subtractor 16 to subtract the ambient light source 40 according to the signals obtained from the optical sensor 13 in the aforesaid two situations so as to output a feedback signal simply generated by sensing the backlight elements 12, and calibrates the optical performance of the backlight elements 12 of the display device 10.

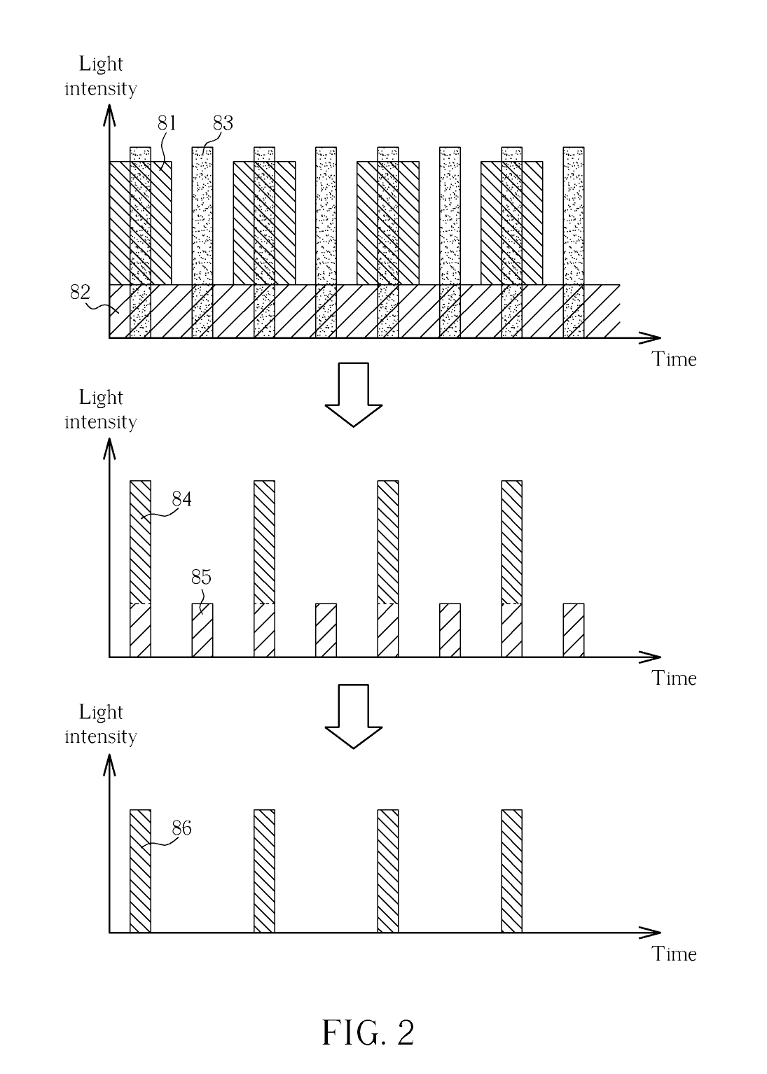

Please refer to FIG. 2. FIG. 2 is a schematic diagram showing that the optical sensor 13 samples and outputs the feedback signal in the first embodiment. In order to control the optical sensor 13 to sense both when the backlight elements 12 is turned on and turned off, the light source driver 14 drives the backlight elements 12 at a specific frequency, and the controller 15 controls the optical sensor 13 to sense at a frequency doubling the specific frequency. Fox example, in FIG. 2, the backlight elements 12 generates a backlight signal 81 at a first frequency, the ambient light source 40 generates an ambient light signal 82, and the optical sensor 13 outputs a sampling signal 83 at a frequency doubling the first frequency. In such a manner, the optical sensor 13 outputs a first signal 84 including the backlight signal 81 and the ambient light signal 82 and a second signal 85 including the ambient light signal 82 only. Then, a feedback control signal 86 simply contributed by the backlight elements 12 can be outputted by using the subtractor 16 to subtract the second signal 85 from the first signal 84. Finally, the display device 10 calibrates the backlight light source generated by the backlight elements 12 according to the feedback signal 86.

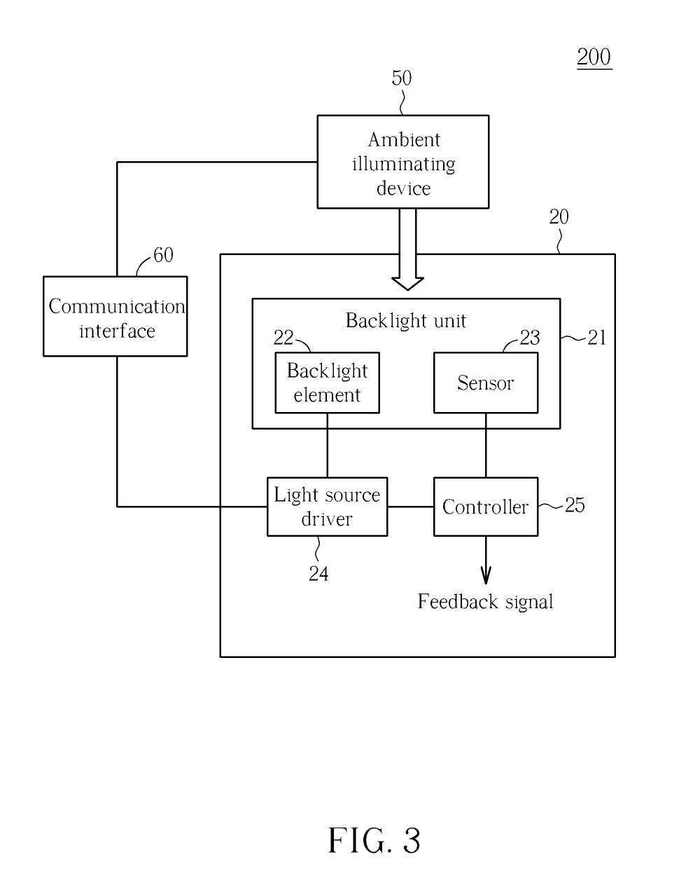

Furthermore, if the light emitting diode is used for illuminating the environment, the present invention can further combine the ambient light source and the output of the display device to make the display device have a better performance. Please refer to FIG. 3. FIG. 3 is a block diagram of a light feedback control system 200 of a second embodiment of the present invention. The functions and the structures of a display device 20, a backlight unit 21, a backlight element 22, an optical sensor 23, and alight source driver 24 are similar to those in the first embodiment. In the second embodiment, the ambient light is provided by an ambient illuminating device 50. Furthermore, in order to effectively implementing the system of the second embodiment of the present invention, the display device 20 for light feedback control is disposed in a space in which the ambient illuminating device 50 is the only ambient light source. Both of the ambient illuminating device 50 and the backlight element 22 are light emitting diodes or cold cathode fluorescent lamps driven by the light source drivers respectively. A communication interface 60 is further disposed between the ambient illuminating device 50 and the display device 20 and conveys signals between the ambient illuminating device 50 and the display device 20 in a wired (cable transmission interface) or a wireless (infrared ray interface or radio frequency) manner. The light illuminating device 50 is driven to emit lights by its light source driver, or it can also be driven by the light source driver 24 in the display device 20 via the communication interface 60. The light source driver 24 in the display device 20 drives the backlight element 22 to emit light at a first frequency. The ambient illuminating device 50 conveys signals with the light source driver 24 via the communication interface 60 and generates an ambient light source at the first frequency. In this embodiment, the backlight element 22 and the ambient illuminating device 50 are driven to emit light alternately, that is, the light source driver 24 drives the backlight element 22 to emit light when the ambient illuminating device 50 is turned off. The controller 25 synchronizes with the light source driver 24 so as to drive the optical sensor 23. Accordingly, the controller 25 can control the optical sensor 23 to sense only the backlight light source generated from the backlight element 22.

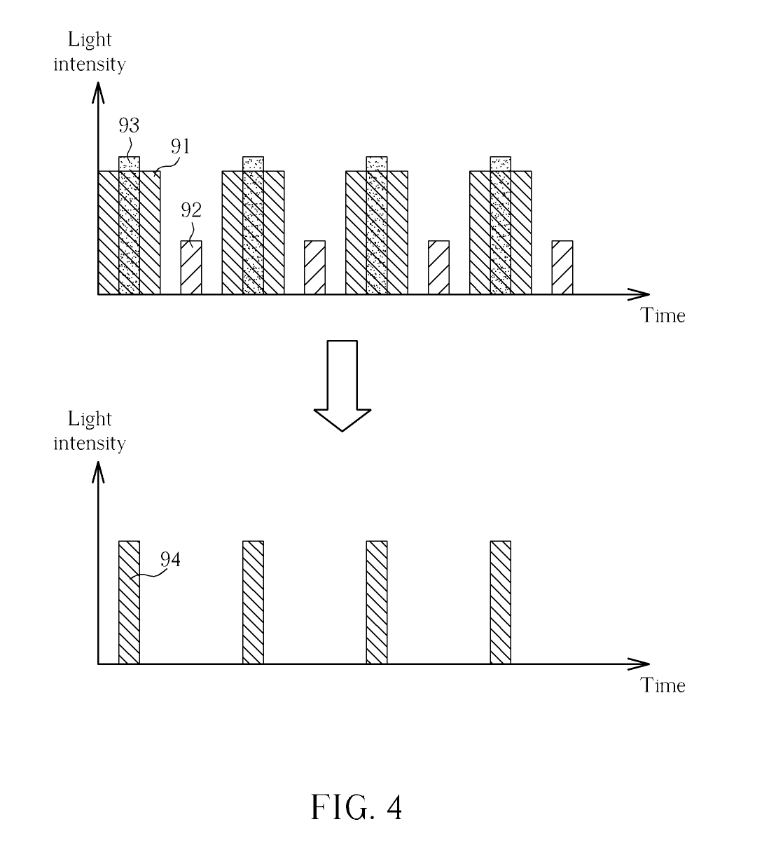

Please refer to FIG. 4. FIG. 4 is a schematic diagram showing that the optical sensor 23 samples and outputs the feedback signal in the second embodiment of the present invention. As shown in FIG. 4, the backlight element 22 is intermittently driven by the light source driver 24 for emitting a backlight signal 91. The backlight signal 91 and an ambient light signal 92 emitted from the ambient illuminating device 50 are alternately generated, while a sampling signal 93 of the optical sensor 23 is generated synchronously with operation of the backlight element 22. In such a manner, only the backlight signal 91 of the backlight element 22 in the backlight unit 21 can be sensed by the optical sensor 23 and is outputted as a feedback signal 94, while the ambient illuminating device 50 is turned off and does not interfere with the optical sensor 23. When the backlight element 22 is turned off and the optical sensor 23 stops sampling, the ambient illuminating device 50 is then driven to emit light. Accordingly, as the ambient light source is a light emitting diode that can be driven by the light source driver, the ambient light source and the backlight element of the backlight unit 21 can be easily driven in an alternate way. The optical sensor 23 of the display device 20 then can sense a more precise signal without being affected by the ambient light source. Furthermore, for the ambient illuminating device 50 that includes plural independent light emitting diode sources, the light emitting diode sources can be synchronized by conveying signals with the display device 20 via the communication interface 60 and to alternately emit lights in an aforesaid manner.

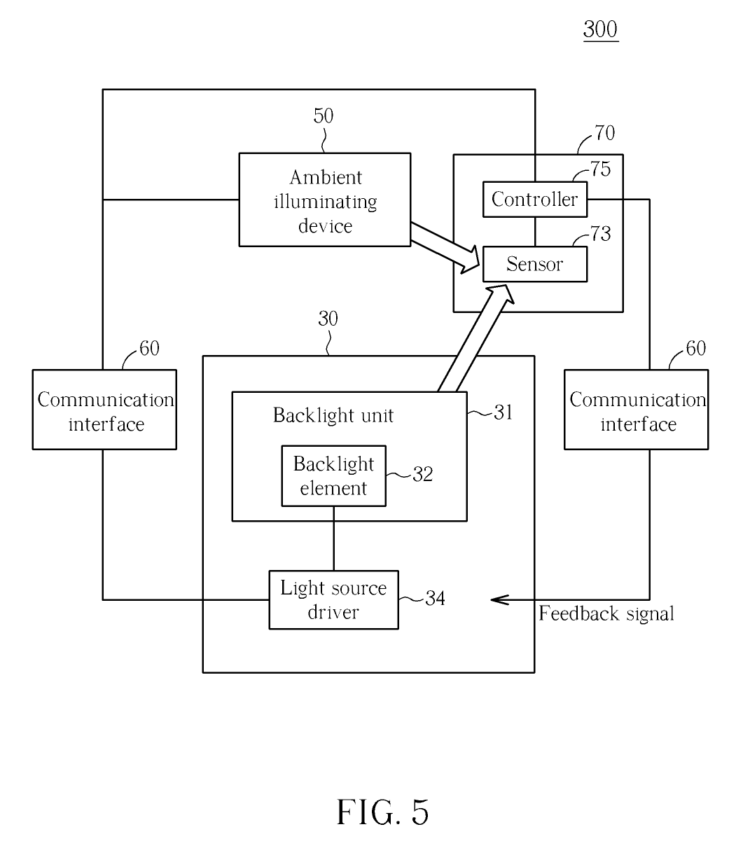

In the aforesaid light feedback control systems 100,200, the optical sensors 13,23 for generating the feedback information are disposed in the backlight units 11,21 of the display devices 10,20. According to a third embodiment of the present invention, the optical sensor may also be disposed outside the display device, such as on a remote control. In such a manner, the display device can control the light intensity and color of the liquid crystal panel more precisely. As a light feedback control system 300 shown in FIG. 5, the functions and the structures of a backlight unit 31, a backlight element 32, and a light source driver 34 in the display device 30 are similar to those in the aforesaid embodiments. In the third embodiment, the optical sensor 73 and the controller 75 are disposed on a remote control device 70 or on a wall outside the display device 30. Both of the controller 75 and the ambient illuminating device 50 convey signals with the light source driver 34 in a wired or wireless manner via the communication interface 60, and the light illumination device 50 is driven alternately with the optical sensor 73 and the backlight element 32. In such a manner, the optical sensor 73 is controlled by the controller 75 to synchronously sense the backlight light source of the backlight element 32, so as not to be interfered by the ambient light source of the ambient illuminating device 50. Accordingly, the controller 75 transmits the feedback signal generated from the optical sensor 73 to the display device 30 via the communication device 60 for calibration of the display device 30.

For the embodiment in FIG. 5, the first embodiment in FIG. 1 may also be incorporated herein, i.e., the optical sensor 73 is controlled by the controller 75 to sense the backlight element 32 and the ambient light source at the double sampling frequency in a persisting ambient light source. Afterwards, a correct feedback signal can be obtained by using the subtractor to subtract the effect of the ambient light source.

In the light feedback control system of the present invention, the correct light feedback signal for the backlight source can be obtained by using the optical sensor disposed inside the backlight unit or outside the display device after subtracting the effect of ambient light sensed by the optical sensor when the backlight element is turned off. The optical sensor senses light intensity and the ambient light source at a double frequency of the frequency at which a backlight element emits light. The light feedback control system may further control the ambient light source and the backlight element and drive them to illuminate alternately, while the optical sensor synchronizes with the backlight element and senses light signals of the backlight element. Accordingly, exact information about the light intensity or color of the backlight element can be obtained for feedback control of the display device.

Those skilled in the art will readily observe that numerous modifications and alterations of the device and method may be made while retaining the teachings of the invention.

What is claimed is:

1. A light feedback control system, comprising:
a light source driver connected to a backlight element for driving the backlight element;
an optical sensor; and
a controller connected to the optical sensor and the light source driver, the controller controlling the optical sensor to sense a light source both when the backlight element is turned on and turned off so as to generate a plurality of signals correspondingly, the controller computing a feedback signal according the plurality of signals, and the feedback signal being used for calibrating optical performance of the backlight element.

2. The light feedback control system of claim 1, wherein the optical sensor senses the light source when the backlight element is turned on and generates a first signal, the optical sensor senses the light source when the backlight element is turned off and generates a second signal, and the controller is used for subtracting the second signal from the first signal so as to output the feedback signal.

3. The light feedback control system of claim 1, wherein the optical sensor is a light sensor or a color sensor, the controller is a pulse width modulation driving circuit or an inverter, and the backlight element is a light emitting diode or a cold cathode fluorescent lamp.

4. A light feedback control system, comprising:
a light source driver connected to a backlight element for driving the backlight element when an ambient illuminating device is turned off;
an optical sensor; and
a controller connected to the optical sensor and the light source driver, the controller controlling the optical sensor to synchronize with the light source driver and sense a light source so as to output a feedback signal, and the feedback signal being used for calibrating optical performance of the backlight element.

5. The light feedback control system of claim 4, wherein the light source driver controls the backlight element to be turned on or turned off by coordinating with the ambient illuminating device via a communication interface.

6. The light feedback control system of claim 4, further comprising a communication interface disposed between the light source driver and the controller, the controller synchronizing with the controller via the communication interface, and the controller outputting the feedback signal to the light source driver via the communication interface.

7. The light feedback control system of claim 6, wherein the communication interface is an infrared ray interface or a radio frequency communication interface, or a wired communication interface connected between the light source driver and the controller.

8. The light feedback control system of claim 6, wherein the optical sensor and the controller are disposed on a remote control device.

9. The light feedback control system of claim 4, wherein the light source driver is a pulse width modulation driving circuit or an inverter, and the optical sensor is a light sensor or a color sensor.

10. The light feedback control system of claim 4, wherein the light feedback control system is disposed in a space in which the ambient illuminating device is the only ambient light source.

11. A light feedback control method, comprising steps:
driving a back light element intermittently;
sensing a light source and outputting a first signal correspondingly when the backlight element is turned on;
sensing the light source and outputting a second signal correspondingly when the backlight element is turned off;
computing a feedback signal according to the first signal and the second signal; and
calibrating optical performance of the backlight element according to the feedback signal.

12. The light feedback control method of claim 11, wherein the feedback signal is computed by subtracting the second signal from the first signal.

13. A light feedback control method, comprising steps:
driving a backlight element and an ambient illuminating device intermittently and alternately;
sensing a light source and outputting a feedback signal correspondingly when the backlight element is turned on; and
calibrating optical performance of the backlight element according to the feedback signal.

14. The light feedback control method of claim 13, further comprising step: using a communication interface to control the backlight element and the ambient illuminating device and drive them to illuminate alternately.
